(19) United States
(12) Patent Application Publication
(10) Pub. No.: US 2025/0130519 A1
(43) Pub. Date: Apr. 24, 2025

(54) IMAGE FORMING APPARATUS

(71) Applicant: CANON KABUSHIKI KAISHA, Tokyo (JP)

(72) Inventors: KOHEI MIZUGUCHI, Ibaraki (JP); YUTA SUZUKI, Ibaraki (JP); DAIKI ISHII, Ibaraki (JP); IKU SHIMIZU, Chiba (JP)

(21) Appl. No.: 18/895,984

(22) Filed: Sep. 25, 2024

(30) Foreign Application Priority Data
Oct. 20, 2023 (JP) 2023-181412

(51) Int. Cl. G03G 15/20; G03G 15/00; G03G 21/14

(52) U.S. Cl. CPC G03G 15/2028; G03G 15/5029; G03G 15/657; G03G 21/145; G03G 2215/00413; G03G 2215/00599; G03G 2215/00738

(57) ABSTRACT

An image forming apparatus includes a transfer portion configured to transfer a toner image onto the sheet, a fixing unit configured to fix the toner image transferred by the transfer portion on the sheet, a detection unit arranged between the transfer portion and the fixing unit in a sheet conveyance direction and configured to detect a bending amount of the sheet nipped by the transfer portion and the fixing unit, and a control unit configured to control a conveyance speed of the sheet conveyed by the fixing unit based on a detection result of the detection unit. The detection unit includes a pivot portion configured to pivot when pressed by the sheet nipped by the transfer portion and the fixing unit, and a rotary encoder configured to output a pulse signal in accordance with a pivot amount of the pivot portion.

### BACKGROUND OF THE INVENTION

### Field of the Invention

This disclosure relates to an image forming apparatus that forms an image on a sheet.

### Description of the Related Art

According to Japanese Patent Laid-Open No. 2005-181507, a loop detection sensor for determining whether or not a loop that a transfer portion and a fixing roller form on a sheet has reached a predetermined amount is proposed. The loop detection sensor includes a mechanical flag that pivots when coming into contact with the sheet, and a photointerrupter that can transition between a light-blocking state and a light-transmitting state when the mechanical flag pivots.

In addition, according to Japanese Patent Laid-Open No. 2007-041188, an image forming apparatus in which two light transmissive type loop detection sensors are disposed between a secondary transfer portion and a fixing unit is proposed. The image forming apparatus includes an actuator that pivots upon contact with the sheet, and the actuator has two projections that can each block optical axes of the two loop detection sensors. These two loop detection sensors output an OFF signal when the optical axis is blocked by the projection and an ON signal when the optical axis is unobstructed. This image forming apparatus can detect four types of the loop amounts based on the combination of the signals from these two loop detection sensors.

Incidentally, the sheet used in the image forming apparatus includes various types such as thin paper, standard paper, and thick paper. Then, an appropriate loop amount is known to vary according to the type of the sheet. However, in Japanese Patent Laid-Open No. 2005-181507, since the loop detection sensor can detect only a single type of the loop amount, it is difficult to control the loop amount (bending amount) in accordance with the various types of the sheets.

In addition, the image forming apparatus described in Japanese Patent Laid-Open No. 2007-041188 necessitates positioning each of the two loop detection sensors and the actuator equipped with the two projections to prevent detection errors, and, thereby, the configuration is complicated.

### SUMMARY OF THE INVENTION

According to one aspect of the present invention, an image forming apparatus includes a transfer portion configured to convey a sheet while nipping the sheet and configured to transfer a toner image onto the sheet, a fixing unit configured to convey the sheet while nipping the sheet and configured to fix the toner image transferred by the transfer portion on the sheet, a detection unit arranged between the transfer portion and the fixing unit in a sheet conveyance direction and configured to detect a bending amount of the sheet nipped by the transfer portion and the fixing unit, and a control unit configured to control a conveyance speed of the sheet conveyed by the fixing unit based on a detection result of the detection unit. The detection unit includes a pivot portion configured to pivot when pressed by the sheet nipped by the transfer portion and the fixing unit, and a rotary encoder configured to output a pulse signal in accordance with a pivot amount of the pivot portion.

Further features of the present invention will become apparent from the following description of exemplary embodiments with reference to the attached drawings.

### BRIEF DESCRIPTION OF THE DRAWINGS

FIG. 1 is an overall schematic diagram illustrating a cross-sectional configuration of an image forming apparatus.

FIG. 2 is a cross-sectional view illustrating a detection unit.

FIG. 3 is a perspective view illustrating the detection unit and a conveyance guide.

FIG. 4 is a side view illustrating the detection unit in a standby state.

FIG. 5 is a side view illustrating the detection unit in a detection state.

FIG. 6 is a graph illustrating changes in a bending amount of a sheet when bending amount control is performed.

FIG. 7 is a schematic diagram illustrating a detection unit of a comparative example.

FIG. 8 is a schematic diagram illustrating a movement of the detection unit of this embodiment.

FIG. 9 is a perspective view illustrating a second flag and a sensor.

FIG. 10 is a side view illustrating the second flag and the sensor.

### DESCRIPTION OF THE EMBODIMENTS

### Overall Configuration

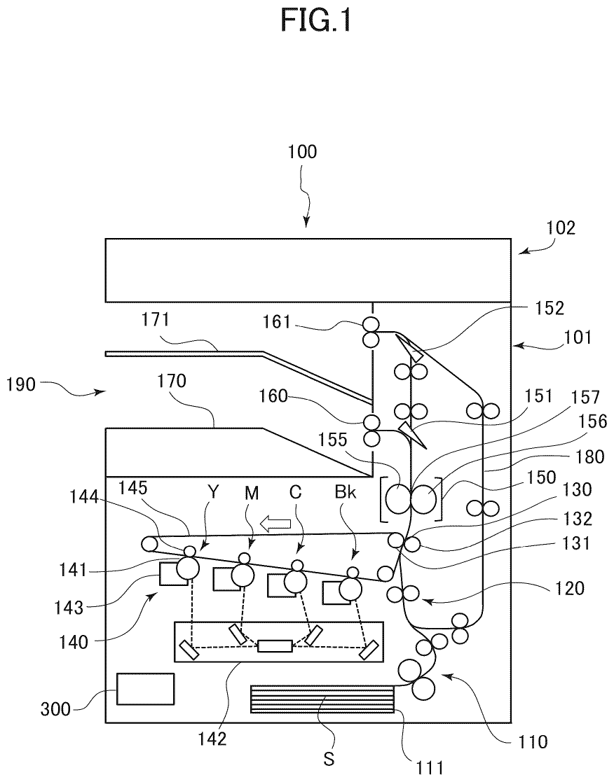

FIG. 1 is an overall schematic diagram illustrating a cross-sectional configuration of an image forming apparatus 100 of this disclosure. The image forming apparatus 100 includes an image forming unit 140 that forms an image on a sheet S, serving as a recording material, a sheet feed unit 110, a fixing unit 150, and an image reading apparatus 102. In addition, the image forming apparatus 100 includes an apparatus body 101, serving as a casing incorporating the image forming unit 140.

The image forming unit 140 is an electrophotographic unit of an intermediate transfer tandem method in which image forming stations Y, M, C, and Bk forming toner images of four colors are arranged along an intermediate transfer belt 145.

The sheet S is stored in a cassette 111 disposed in a lower part of the apparatus body 101, and is fed by the sheet feed unit 110 one sheet at a time. For the sheet feed unit 110, for example, a unit including a feed roller that feeds the sheet, and a separation roller that is arranged to come into contact with the feed roller to apply a friction force on the sheet S to separate other sheets S from the sheet S is used. To be noted, as the sheet S, serving as the recoding material, diverse sheets with varying sizes and materials can be used, and the sheet S includes paper such as standard paper and thick paper, a plastic film, cloth, a surface treated sheet material such as coated paper, specially shaped sheet material such as an envelope and index paper, and the like.

The sheet S fed from the sheet feed unit 110 is corrected for skew by a skew correction unit 120, and is conveyed toward a transfer nip 130 in a timing that synchronizes with a toner image formation process by the image forming unit 140. The transfer nip 130, serving as a transfer portion, is a nip portion formed between a secondary transfer inner roller 131 and a secondary transfer outer roller 132, which substantially face each other across an intermediate transfer belt 145 and conveys the sheet S while nipping the sheet S.

In parallel with the conveyance process of the sheet S to the transfer nip 130 described above, the image forming unit 140 performs the toner image formation process. Each of the image formation stations Y, M, C, and Bk of the image forming unit 140 includes a photosensitive drum 141 that is a drum shaped image bearing member (electrophotographic photosensitive member), a charge unit such as a charge roller, and a developing unit 143, serving as a developing unit. In addition, the image forming unit 140 includes an exposing unit 142 arranged below the four photosensitive drums 141. In the toner image formation process, the charge unit uniformly charges a surface of the photosensitive drum 141, and the exposing unit 142 exposes the photosensitive drum 141 based on a signal of image information to be formed and writes an electrostatic latent image on the surface of the photosensitive drum 141. This electrostatic latent image is developed by toner supplied from the developing unit 143, and becomes a monochromatic toner image. Thereby, the toner images of four colors i.e., yellow, magenta, cyan, and black are formed on the surfaces of the four photosensitive drums 141.

The intermediate transfer belt 145 is rotatably driven in a counter-clockwise direction in FIG. 1. The toner images borne by the four photosensitive drums 141 are primarily transferred onto the intermediate transfer belt 145 by primary transfer rollers 144 to overlap each other in sequence. Consequently, finally, the toner image of a full color is formed on the intermediate transfer belt 145, and is conveyed to the transfer nip 130 by being borne by the intermediate transfer belt 145. Then, by a pressure force and an electrostatic bias at the transfer nip 130, the toner image is secondarily transferred onto the sheet S from the intermediate transfer belt 145.

The sheet S that has passed through the transfer nip 130 is conveyed to the fixing unit 150. The fixing unit 150 includes a fixing roller 155 that incorporates a heater, and a pressing roller 156 that comes into contact with the fixing roller 155 with a predetermined pressure force. The fixing roller 155 is driven by a drive source such as a motor, not shown, and the pressing roller 156 is rotatably driven by the fixing roller 155. While nipping and conveying the sheet S at a fixing nip formed by the fixing and pressing rollers 155 and 156, the fixing unit 150 applies heat and pressure to the toner image on the sheet S. Thereby the toner melts, and, after passing through the fixing nip, is secured to produce the image fixed on the sheet S.

The sheet S that has passed through the fixing unit 150 is guided by a first guide member 151 to either a path toward a first sheet discharge roller pair 160 or a path toward a second sheet discharge roller pair 161. In a case of performing the image formation on both sides of the sheet S, the sheet S on whose first surface the image has been formed is guided toward the second sheet discharge roller pair 161 by the first guide member 151, and is conveyed toward the outside of the apparatus by the second sheet discharge roller pair 161. When a trailing edge of the sheet S in a conveyance direction has passed through a second guide member 152, the second sheet discharge roller 161 reverses the conveyance direction of the sheet S, and sends the sheet S to a duplex conveyance path 180. During a reverse operation by the second sheet discharge roller pair 161, a part of the sheet S protruding outside of the apparatus body 101 is supported by a second sheet discharge tray 171. After the skew correction and a timing adjustment, by passing through the transfer nip 130 and the fixing unit 150, the image is formed on a second surface of the sheet S that has again reached the skew correction unit 120 via the duplex conveyance path 180.

In a case of discharging the sheet S, the sheet S sent from the fixing unit 150 is guided to the first sheet discharge roller pair 160 by the first guide member 151, and is discharged outside of the apparatus body 101 by the first sheet discharge roller pair 160. A first sheet discharge tray 170 is disposed on the top of the apparatus body 101, and the sheet S discharged by the first sheet discharge roller pair 160 is supported on the first sheet discharge tray 170. Upper surfaces of the first and second sheet discharge trays 170 and 171 are inclined upward toward downstream sides in the sheet conveyance direction. The sheet S supported on the first or second sheet discharge tray 170 or 171 slides upstream in the sheet conveyance direction by its own weight following an inclination of the first or second sheet discharge tray 170 or 171. Alignment surfaces extending in the vertical direction are disposed on upstream sides of the first and second sheet discharge trays 170 and 171 in a sheet discharge direction. When the trailing edge of the sheet S that slides along the inclination of the first or second sheet discharge tray 170 or 171 abuts against the alignment surface, a position of a sheet bundle supported on the first or second sheet discharge tray 170 or 171 is aligned.

Incidentally, the image forming apparatus 100 includes the image reading apparatus 102 mounted on the top of the apparatus body 101. The image reading apparatus 102 includes a platen glass on which a document is placed, and an image sensor that reads an image of the document via the platen glass. In addition, the image reading apparatus 102 includes an auto document feeder for feeding the document set on a document tray one sheet at a time and reading the image by the image sensor. The image forming apparatus 100 of this embodiment utilizes a configuration of a so-called in-drum discharge type, in which an in-drum sheet discharge space 190 for the sheet S is arranged between the image forming unit 140 and the image reading apparatus 102 in the vertical direction. In comparison with a configuration in which the sheet discharge space is arranged on a side of the apparatus body 101 by disposing the first sheet discharge tray 170 on the side of the apparatus body 101, the configuration of the in-drum discharge type offers an advantage that, for example, it is possible to reduce an area occupied by the image forming apparatus 100 when viewed from the above.

In addition, the image forming unit 140 described above is an example of an image forming unit, and, for example, it is acceptable to use an electrophotographic unit of a direct transfer method that directly transfers the toner image formed on the photosensitive drums onto the sheet without using an intermediate transfer member.

### Detection Unit

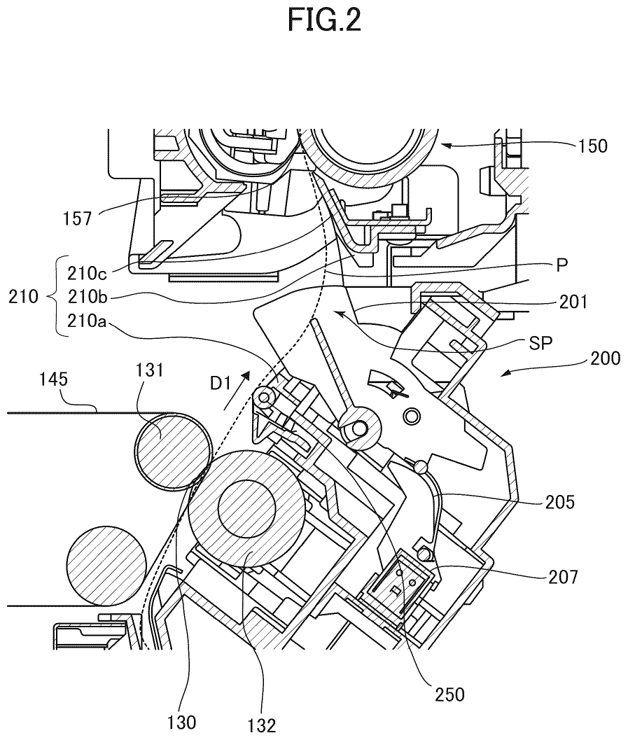

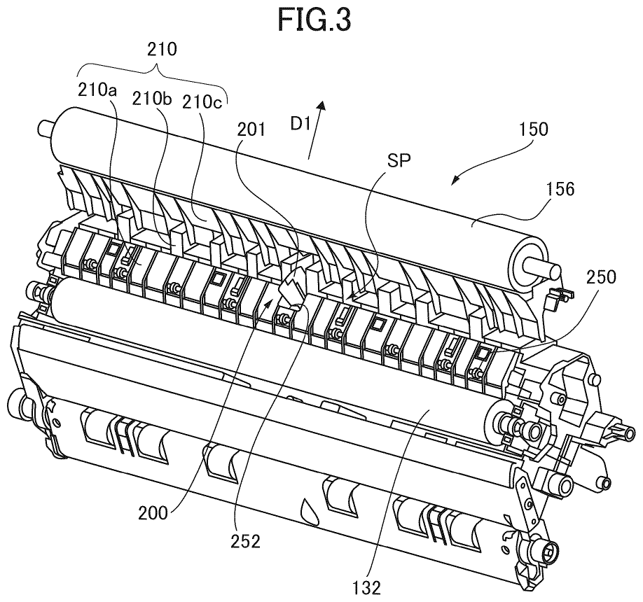

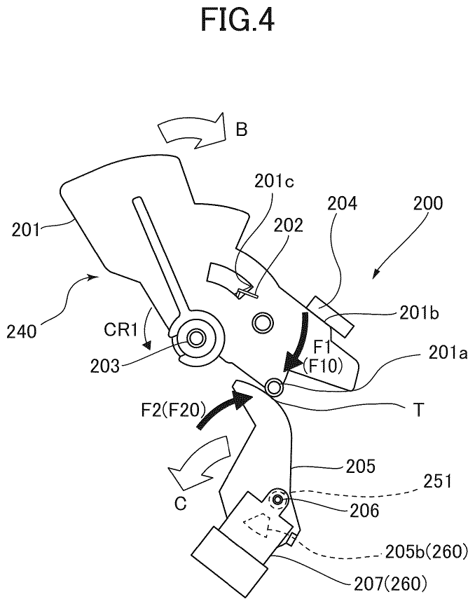

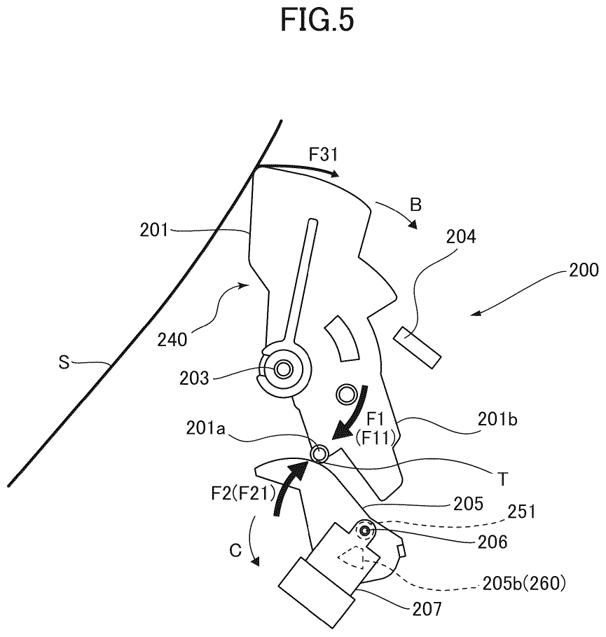

Next, a detection unit 200 arranged between the transfer and fixing nips 130 and 157 in the sheet conveyance direction D1 and a configuration around the detection unit 200 will be described. FIG. 2 is a cross-sectional view illustrating the detection unit 200. FIG. 3 is a perspective view illustrating the detection unit 200 and a conveyance guide 210. FIG. 4 is a side view illustrating the detection unit 200 in a standby state. FIG. 5 is a side view illustrating the detection unit 200 in a detection state.

As illustrated in FIG. 2, the sheet S is conveyed in the sheet conveyance direction D1 by the transfer nip 130. The conveyance guide 210 and the detection unit 200 are arranged between the transfer and fixing nips 130 and 157 in the sheet conveyance direction D1. The conveyance guide 210 is arranged only on a non-image surface side of the sheet S to prevent the disruption of an unfixed image on the sheet S. That is, the conveyance guide 210 is not disposed on an image surface side on which the sheet S comes into contact with the intermediate transfer belt 145, the image surface side of the sheet does not come into sliding contact with any members of the apparatus body 101 in a section from the transfer nip 130 to the fixing nip 157.

The conveyance guide 210, serving as a guide member, is constituted by a first guide portion 210a, a second guide portion 210b, and a third guide portion 210c. These first, second, and third guide portions 210a, 210b, and 210c may be formed either integrally or separately with respect to each other. The first guide portion 210a supports a plurality of driven rollers 250 that are rotatably driven by coming into sliding contact with the non-image surface of the sheet S. As illustrated in FIG. 5, the plurality of driven rollers are arranged in parallel in a width direction W.

The conveyance guide 210 does not linearly guide the sheet S between the transfer and fixing nips 130 and 157, and, as illustrated by a dashed line in FIG. 2, is configured to enable the sheet S to bend to a side of the conveyance guide 210. As described above, the conveyance guide 210 forms a loop formation space SP in which the sheet S can bend. Here, in this embodiment, when viewed in a rotational axis direction of the secondary transfer outer roller 132, transitioning to a state in which the sheet S is not linear but curved is referred to as “bending” or “forming a loop”. That is, in this embodiment, “loop” refers to the bending of the sheet S.

As illustrated in FIG. 3, the detection unit 200 is arranged in a central portion of the loop formation space SP in the width direction W. In other words, the detection unit 200 is arranged in a central portion, of a conveyance path between the transfer and fixing nips 130 and 157, in the width direction W. The width direction W is a direction perpendicular to the sheet conveyance direction D1, and is a direction parallel to the rotational axis directions of the secondary transfer outer roller 132 and the pressing roller 156. The detection unit 200 can detect a bending amount of the sheet S in the loop formation space SP. The bending amount refers to an amount (distance) by which the sheet S bends from a straight line state toward the loop formation space SP when viewed in the width direction W. For example, the bending amount can be expressed as a distance from a straight line, which connects the contact points of the plurality of driven rollers 250 with the sheet S and the fixing nip 157, to an apex of the bending (loop) formed on the sheet S.

The detection unit 200 is arranged substantially in a central position between the transfer and fixing nips 130 and 157 in the sheet conveyance direction D1, and can accurately detect the bending amount of the sheet S. In addition, since the detection unit 200 is arranged in the central portion in the loop formation space SP in the width direction, the detection unit 200 can detect the bending amount of the sheet ranging from the smallest to the largest size that the image forming apparatus 100 can use.

As illustrated in FIG. 4, the detection unit 200 includes a first flag 201, serving as a first pivot member, a second flag 205, serving as a second pivot member, and a sensor 207. The first flag 201 is pivotably supported around a first pivot shaft 203 as a center, and includes a contact portion 201a, an abutment portion 201b, and a spring supporting portion 201c. The contact portion 201a is configured to come into contact with or slidably engage with the second flag 205, and a first end portion of a first flag spring 202 is secured to the spring supporting portion 201c.

The first flag spring 202, serving as a first urging member, is constituted by, for example, a torsion coil spring, and a coil portion of the first flag spring 202 is supported by the first pivot shaft 203. Then, the first end portion extending in one direction from the coil portion of the first flag spring 202 is secured to the spring supporting portion 201c, and a second end portion extending in the other direction from the coil portion is secured to a fixing member of the apparatus body 101. By such a first flag spring 202, the first flag 201 is urged in a F1 direction, serving as a first pivot direction, around the first pivot shaft 203 as a center.

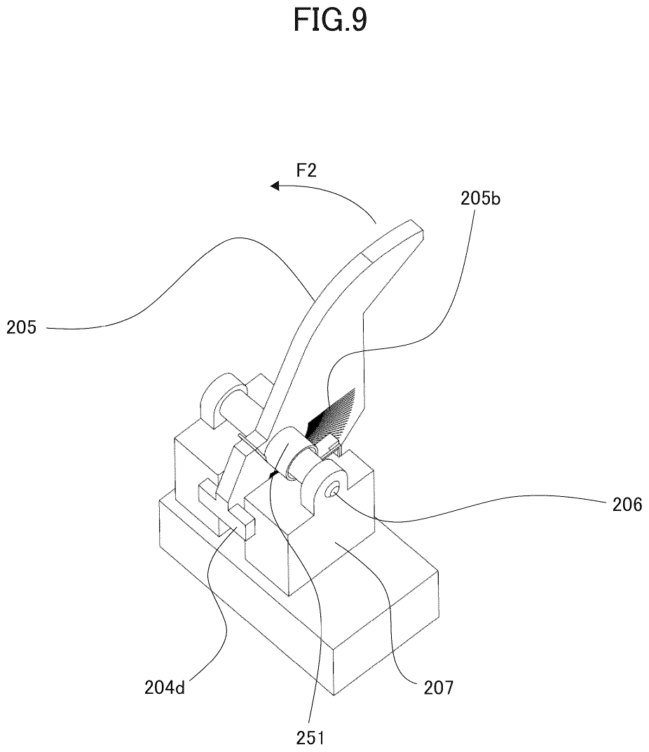

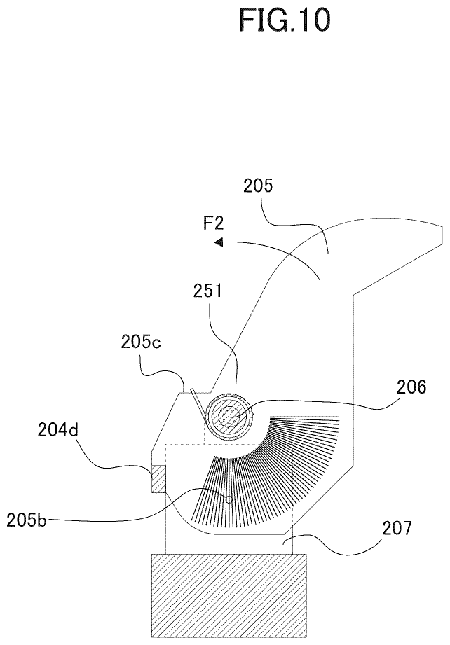

FIG. 9 is a perspective view illustrating the second flag 205 and the sensor 207. FIG. 10 is a side view illustrating the second flag 205 and the sensor 207. As illustrated in FIGS. 4, 9, and 10, the second flag 205 is pivotably supported by a second pivot shaft 206, which is different from the first pivot shaft 203, as a center, and includes a detected portion 205b. A second flag spring 251, serving as a second urging member, is constituted by, for example, a torsion coil spring, and a coil portion of the second flag spring 251 is supported by the second pivot shaft 206. Then, a first end portion extending in one direction from a coil portion of the second flag spring 251 is secured to a spring supporting portion 205c of the second flag 205, and a second end portion extending in the other direction from the coil portion is secured to a spring supporting portion 207c disposed in the sensor 207. To be noted, the second end portion of the second flag spring 251 may be secured to the other fixing member of the apparatus body 101. By such a second flag spring 251, the second flag 205 is urged in a F2 direction, serving as a third pivot direction, around the second pivot shaft 206 as a center.

As illustrated in FIG. 4, when the detection unit 200 is in the standby state, at a contact point T between the contact portion 201a and the second flag 205, an urging force F20 by the second flag spring 251 is set to be larger than an urging force F10 by the first flag spring 202. That is, F20>F10 is satisfied. Therefore, the first flag 201 is urged in a CR1 direction, which is opposite to the F1 direction, around the first pivot shaft 203 as a center, and is maintained in a state in which the abutment portion 201b of the first flag 201 abuts against a stopper 204. The stopper 204 is supported by a fixing member of the apparatus body 101, and regulates a pivot of the first flag 201 in the CR1 direction, serving as a fourth pivot direction. At this time, the first and second flags 201 and 205 are positioned at the respective standby positions.

As illustrated in FIG. 3, an opening 252 is provided in the first guide portion 210a, and the first flag 201 that is positioned at the standby position projects from the opening 252 to the loop formation space SP. Since the first flag 201 projects into the loop formation space SP as described above, the first flag 201 can come into contact with the sheet S conveyed by the transfer and fixing nips 130 and 157.

As illustrated in FIG. 5, when pressed by the sheet S that is nipped by the transfer and fixing nips 130 and 157, the first flag 201 pivots in an arrow B direction (F1 direction) around the first pivot shaft 203 as a center. When the first flag 201 has pivoted in the arrow B direction (F1 direction) from the standby position as described above, the detection unit 200 is regarded as being in the detection state.

In a case where a force in the F1 direction applied to the first flag 201 by the sheet S is designated as F31, when the detection unit transitions to the detection state, the condition F20<F30+F31 is satisfied. Then, as illustrated is FIG. 5, when the contact portion 201a of the first flag 201 presses the second flag 205, the second flag 205 pivots in an arrow C direction, serving as a second pivot direction opposite to the F2 direction, around the second pivot shaft 206 as a center. The arrow C direction is a direction opposite to the arrow B direction (F1 direction).

The first and second flags 201 and 205 stop when an urging force F11 by the first flag spring 202, an urging force F21 by the second flag spring 251, and the force F31 by the sheet S satisfy the condition F21=F11+F31 at the contact point T. Positions where the first and second flags 201 and 205 stop after they each have pivoted from the standby positions are designated as the detection positions.

As described above, the second flag 205 pivots from the standby position to the detection position in synchronization with the pivot of the first flag 201 upon being pressed by the sheet S. These first and second flags 201 and 205 constitute a pivot portion 240 that pivots upon being pressed by the sheet S. Then, the sensor 207 can detect a pivot amount of the second flag 205 from the standby position to the detection position. For example, the sensor 207 is constituted from a photointerrupter including a light emitting element and a light receiving element, and the rotary encoder 260 of a photoelectric type is constituted by the sensor 207 and the detected portion 205b formed in the second flag 205. The light emitting element of the photointerrupter is constituted from, for example, a light emitting diode, and the light receiving element is constituted from, for example, a phototransistor.

In a case where the rotary encoder 260 is a transmissive type encoder, the detected portion 205b includes a plurality of slits that allow light emitted from the light emitting element to pass through. In a case where the rotary encoder 260 is a reflection type encoder, the detected portion 205b includes a plurality of concave-convex structures or slits that can either reflect or not reflect the light emitted from the light emitting element. The light receiving element of the sensor 207 outputs a current corresponding to an amount of received light, and a waveform forming circuit within the rotary encoder 260 converts a waveform of the current into a pulse signal, which is then output as a voltage signal. In other words, the rotary encoder 260 reads the number of the plurality of concave-convex structures or slits corresponding to a pivot amount of the pivot portion 240, and outputs the pulse signal.

As described above, since the rotary encoder 260 outputs the pulse signal according to the pivot amount of the second flag 205 that pivots in conjunction with the first flag 201, the detection unit 200 can detect the bending amount of the sheet. To be noted, the resolution of the rotary encoder 260 can be set arbitrarily, and the rotary encoder 260 of the detection unit 200 can detect at least equal to or more than three loop amounts of the sheet S.

### Bending Amount Control

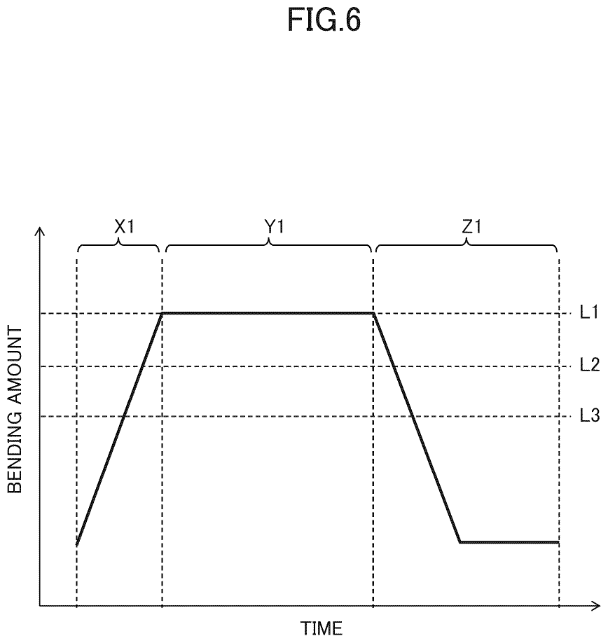

Next, the bending amount control (loop amount control) of the sheet S by a control unit 300 will be described. FIG. 6 is a graph illustrating changes in the bending amount of the sheet S when the bending amount control is performed. The control unit 300 (refer to FIG. 1) includes a central processing unit (CPU), a read only memory (ROM), and a random access memory (RAM). The CPU reads and performs various programs stored in the ROM. The RAM is used as a workspace of the CPU. Based on a detection result of the detection unit 200, the control unit 300 can perform the bending amount control to control a conveyance speed of the sheet S conveyed by the fixing nip 157.

In this embodiment, the conveyance speed of the sheet S by the fixing nip 157 is set to be slightly slower than a conveyance speed of the sheet S by the transfer nip 130. Therefore, the sheet S conveyed by the transfer nip 130 is conveyed to gradually bend after reaching the fixing nip 157. This is indicated in a first region X1 in FIG. 6. In addition, a solid line in FIG. 6 illustrates the bending amount control when conveying the thin paper with relatively low stiffness, and the conveyance of the thin paper between the transfer and fixing nips 130 and 157 with the bending amount maintained at a value L1 is regarded as appropriate. When the conveyance speeds of the sheet S by the transfer and fixing nips 130 and 157 are respectively referred to as a speed V1 and a speed V2, in the first region X1, V2<V1.

Then, in a case where the control unit 300 determines that, based on the detection result of the detection unit 200, the bending amount of the sheet S has reached a bending amount (L1) suitable for the thin paper, as illustrated in a second region Y1 in FIG. 6, the control unit 300 controls the fixing unit 150 such that the speed V2 becomes the same value as the speed V1. Further, as illustrated in a third region Z1 in FIG. 6, based on the detection result of the detection unit 200, the control unit 300 reduces the bending amount to a state in which a certain extent of the bending amount remains at a time shortly before the trailing edge of the sheet S passes through the transfer nip 130. That is, in the third region Z1, the control unit 300 controls the fixing unit 150 such that V1<V2, and, after the bending amount has become a predetermined amount, controls the fixing unit 150 such that V1=V2.

As described above, based on the detection result of the detection unit 200, the control unit 300 controls the fixing unit 150 such that the bending amount, which is set according to a type of the sheet S, is formed on the sheet S for at least predetermined duration. In FIG. 6, for example, a value L3 is a bending amount that is set when conveying the thick paper with relatively high stiffness, and a value L2 is a bending amount that is set when conveying the standard paper with stiffness intermediate between the thin paper and the thick paper.

To be noted, the thin paper is a sheet whose grammage is, for example, 52 to 59 grams per square meter (g/m²), the standard paper is a sheet whose grammage is, for example, 64 to 105 g/m², and the thick paper is a sheet whose grammage is, for example, 106 to 300 g/m².

Incidentally, if the intermediate transfer belt 145 receives an external force from the sheet S at the transfer nip 130 when primarily transferring the image from the photosensitive drum 141 onto the intermediate transfer belt 145, there is a risk that a position of the toner image transferred from the photosensitive drum 141 onto the intermediate transfer belt 145 may be misaligned. Because of this, sometimes, image defects caused by color misregistration occur in a full color toner image which is completed by superimposing the toner images of four colors. Therefore, it is preferable that the external force from the sheet S, which is nipped by the transfer and fixing nips 130 and 157, is not exerted onto the intermediate transfer belt 145.

In addition, if a posture of the sheet S is unstable at a position upstream of the fixing nip 157 in the sheet conveyance direction D1, wrinkles sometimes occur in the sheet S during the passage of the sheet S through the fixing nip 157. In addition, when the sheet S nipped by the transfer and fixing nips 130 and 157 enters a tensioned state, the unfixed image on the sheet S may sometimes become distorted when the trailing edge of the sheet S passes through roller pairs located upstream of the transfer nip 130 in the sheet conveyance direction D1. To prevent such image defects and wrinkles in the sheet described above, there is an appropriate bending amount according to such as the type, size, and stiffness of the sheet S.

For example, generally, a stiffer sheet produces a greater reaction force when bent, and increases the external force exerted onto the intermediate transfer belt 145 from the sheet S. Therefore, in this embodiment, it is possible to perform the bending amount control to achieve such that, by respectively setting to target the values L1, L2, and L3 for the thin paper, standard paper, and thick paper as the bending amount, the bending amount is appropriate in accordance with the type of the sheet. That is, in a case of conveying the sheet S of a first stiffness, the control unit 300 controls the conveyance speed of the sheet S by the fixing nip 157 such that the bending amount of the sheet S becomes a first bending amount. In addition, in a case of conveying the sheet S of a second stiffness that is lower than the first stiffness, the control unit 300 controls the conveyance speed of the sheet S by the fixing nip 157 such that the bending amount of the sheet S becomes a second bending amount, which is larger than the first bending amount.

Thereby, even when conveying various types of sheets, it is possible to suppress the image defects and the wrinkles in the sheet. Then, the reason why it is possible to control the bending amount of sheet S to target different values according to the type of the sheet S is because the rotary encoder 260 can output the pulse signal corresponding to the pivot amount of the second flag 205 and can detect the bending amount of the sheet S in real-time and with high accuracy.

To be noted, while, in this embodiment, as described above, the target bending amount is set at three levels of L1, L2, and L3, it is not limited to this. For example, it is acceptable to set equal to or more than four levels of the bending amount according to the type, size, and stiffness of the sheet.

### Comparative Example

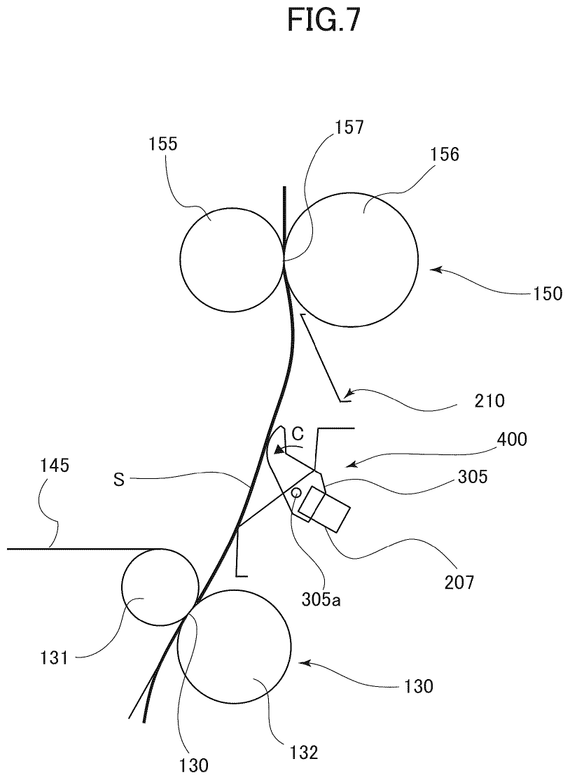

Here, using FIG. 7, a detection unit 400 of a comparative example will be described. FIG. 7 is a schematic diagram illustrating the detection unit 400 of the comparative example. To be noted, since configurations other than the detection unit 400 are the same as the embodiment described above, descriptions of the same configurations as this embodiment will be omitted by putting the same reference characters on FIG. 7.

As illustrated in FIG. 7, the detection unit 400 includes a flag 305 that can pivot around a pivot shaft 305a as a center when pressed by the sheet S that is nipped by the transfer and fixing nips 130 and 157, and the sensor 207. That is, the detection unit 400 of the comparative example is configured with only one flag, as opposed to the configuration of this embodiment which employs two flags.

The flag 305 is urged in the arrow C direction by a flag spring, not shown, and is positioned at the standby position by abutting against a stopper, not shown. That is, the flag 305 is always attempting to return to the standby position by a predetermined urging force applied by the flag spring. This predetermined urging force applied by the flag spring becomes resistance with respect to the sheet S that presses the flag 305.

In particular, since, in a section between the transfer and fixing nips 130 and 157, the conveyance guide 210 is disposed only on the non-image surface side, there is a risk that, depending on the stiffness of the sheet S, a force to push the flag 305 may be insufficient and it may not be possible to detect the bending amount of the sheet S. Especially, there is a risk that the sheet, such as the thin paper, whose stiffness is relatively low, may not be able to push the flag 305 from the standby position while resisting the urging force of the flag spring, and detection errors by the detection unit 400 may occur.

### Acts of First Flag and Second Flag

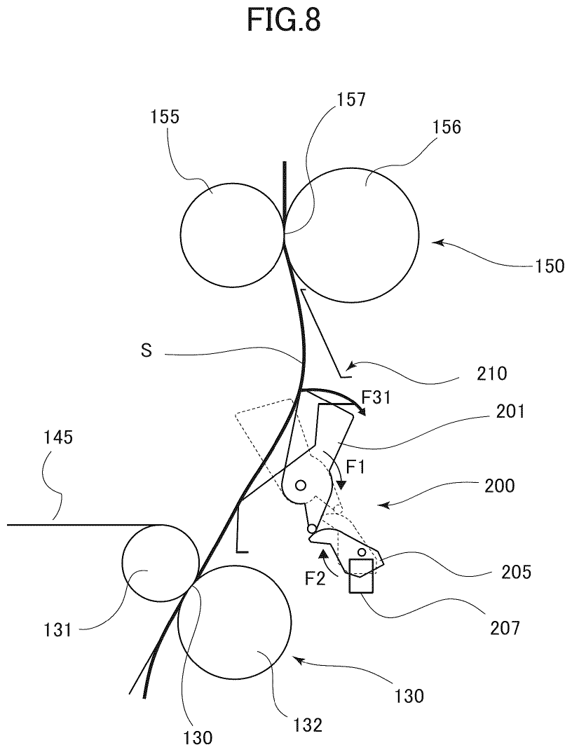

FIG. 8 is a schematic diagram illustrating a movement of the detection unit 200 of this embodiment. As illustrated in FIGS. 4, 5, and 8, in this embodiment, the first flag 201 is urged in the F1 direction by the first flag spring 202, and the second flag 205 is urged in the F2 direction opposite to the F1 direction by the second flag spring 251. Then, the first and second flags 201 and 205 are urged to press each other by the first and second flag springs 202 and 251. In addition, the first flag spring 201 urges the first flag 201 in the same direction that the sheet S, which is bent, presses the first flag 201. In addition, in this embodiment, when the detection unit 200 is in the standby state, the urging force F10 by the first flag spring 202 is set to become slightly smaller than the urging force F20 by the second flag spring 251.

With this configuration, the sheet S that presses the first flag 201 can apply pressure to the first flag 201 with a minimal amount of force. That is, the force F31 received by the first flag 201 from the sheet S, which is required to pivot the first flag 201 from the standby position in the F1 direction is sufficiently small. In other words, a resistance force that the sheet S, which comes into contact with the first flag 201, receives from the first flag 201 when pressing the first flag 201 is small, and, even in a case of the low stiffness sheet, such as the thin paper, can reliably press the first flag 201. Therefore, it is possible to reduce the detection errors by the detection unit 200.

As described above, in this embodiment, since the detection unit 200 that includes the rotary encoder 260 detects the bending amount of the sheet S at the plurality of levels, with a simple configuration, it is possible to control the bending amount in accordance with the various types of the sheets. In addition, since the rotary encoder 260 is configured to be relatively small in size, it is possible to improve the freedom of disposition.

In addition, since the first flag 201 is urged by the first flag spring 202 in the same direction as the direction in which the first flag 201 pivots when pressed by the sheet S, the sheet S can press the first flag 201 from the standby position with the minimal force. Therefore, for example, even if the sheet S is the thin paper having low stiffness, it is possible to reduce the detection errors by the detection unit 200, and it is possible to satisfactorily perform the bending amount control.

Further, since the first and second flags 201 and 205 are urged to come into contact with each other by the urging forces of the first and second flag springs 202 and 251, these first and second flags 201 and 205 are always in contact with each other. Therefore, the pivot of the first flag 201 is immediately transmitted to the second flag 205, and, by detecting the pivot amount of the second flag 205, the sensor 207 can accurately detect the bending amount of the sheet S.

### Other Embodiments

To be noted, while, in the image forming apparatus of this embodiment, a conveyance path from the sheet feed unit 110 to the first and second sheet discharge roller pairs 160 and 161 extends along the vertical direction, it is not limited to this. For example, this disclosure can be applied to an image forming apparatus in which at least part of a conveyance path conveys the sheet S in the horizontal direction.

In addition, while, in this embodiment, the fixing unit 150 is constituted by the fixing roller 155 and the pressing roller 156, it is not limited to this. For example, instead of the fixing roller 155, it is acceptable to apply an endless belt or a film that incorporates a heater, or is acceptable to apply a belt that possesses a heat generation layer heated by electromagnetic induction.

In addition, while the detection unit 200 includes two flags, namely the first and second flags 201 and 205, it is acceptable to include equal to or more than three flags. Further, as illustrated in the comparative example in FIG. 7, the detection unit 200 may include only one flag 305. In addition, while only one detection unit 200 is disposed substantially in the central portion of the loop formation space SP in the width direction W, a plurality of detection units 200 may be disposed in the loop formation space SP. More preferably, two detection units 200 may be positioned symmetrically around the central portion of the loop formation space SP in the width direction W as a center. Thereby, it is possible to also detect the bending in a twisted state of the sheet S.

In addition, while, in this embodiment, the stopper 204 is arranged to abut against the first flag 201, it is not limited to this. For example, the stopper 204 may be arranged to abut against the second flag 205. That is, it is acceptable if the stopper 204 positions the first and second flags 201 and 205 at their respective standby positions by abutting against either one of the first and second flags 201 and 205. In addition, instead of the stopper 204 illustrated in FIG. 4, as illustrated in FIGS. 9 and 10, a stopper 204d may be disposed on a part of the second flag 205. By abutting against the sensor 207, the stopper 204d regulates a movement of the second flag 205 in the F2 direction, and positions the second flag 205 at the standby position.

In addition, if the urging forces of the first and second flag springs 202 and 251 are balanced in their natural states and the first and second flags 201 and 205 are retained at the standby positions, the stopper 204 can be omitted.

In addition, while, in this embodiment, when pressed by the first flag 201 that pivots in the arrow B direction (F1 direction), the second flag 205 pivots in the arrow C direction that is opposite to the arrow B direction (F1 direction), it is not limited to this. For example, when pressed by the first flag 201 that pivots in the arrow B direction (F1 direction), the second flag 205 may pivot in a direction that is the same as the arrow B direction (F1 direction). In this case, the second flag spring 251 urges the second flag 205 in the arrow C direction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2023-181412, filed Oct. 20, 2023, which is hereby incorporated by reference herein in its entirety.

What is claimed is:

1. An image forming apparatus comprising:
a transfer portion configured to convey a sheet while nipping the sheet and configured to transfer a toner image onto the sheet;
a fixing unit configured to convey the sheet while nipping the sheet and configured to fix the toner image transferred by the transfer portion on the sheet;
a detection unit arranged between the transfer portion and the fixing unit in a sheet conveyance direction and configured to detect a bending amount of the sheet nipped by the transfer portion and the fixing unit; and
a control unit configured to control a conveyance speed of the sheet conveyed by the fixing unit based on a detection result of the detection unit,
wherein the detection unit includes:
a pivot portion configured to pivot when pressed by the sheet nipped by the transfer portion and the fixing unit; and
a rotary encoder configured to output a pulse signal in accordance with a pivot amount of the pivot portion.

2. The image forming apparatus according to claim 1, wherein the pivot portion includes:
a first pivot member configured to pivot when pressed by the sheet nipped by the transfer portion and the fixing unit; and
a second pivot member configured to pivot when pressed by the first pivot member, and
wherein the rotary encoder is configured to output the pulse signal in accordance with a pivot amount of the second pivot member.

3. The image forming apparatus according to claim 2, wherein the detection unit is arranged in a conveyance path between the transfer portion and the fixing unit, and arranged in a central portion, of the conveyance path, in a width direction perpendicular to the sheet conveyance direction.

4. The image forming apparatus according to claim 3, further comprising a guide member configured to form the conveyance path and configured to guide the sheet,
wherein the first pivot member is arranged so as to project to the conveyance path from an opening provided in the guide member.

5. The image forming apparatus according to claim 1, wherein the control unit is configured to
(i) in a case of conveying the sheet with first stiffness, control a conveyance speed of the sheet by the fixing unit such that the bending amount of the sheet becomes a first bending amount, and
(ii) in a case of conveying the sheet with second stiffness that is smaller than the first stiffness, control the conveyance speed of the sheet by the fixing unit such that the bending amount of the sheet becomes a second bending amount that is larger than the first bending amount.
